(19) United States
(12) Patent Application Publication
(10) Pub. No.: US 2023/0289851 A1
(43) Pub. Date: Sep. 14, 2023

(54) INFORMATION MANAGEMENT APPARATUS

(71) Applicant: HONDA MOTOR CO., LTD., Tokyo (JP)

(72) Inventors: Yoshihiro Deguchi, Tokyo (JP); Atsushi Enomoto, Tokyo (JP)

(73) Assignee: HONDA MOTOR CO., LTD., Tokyo (JP)

(21) Appl. No.: 18/111,042

(22) Filed: Feb. 17, 2023

(30) Foreign Application Priority Data
Mar. 8, 2022 (JP) 2022-035567

(51) Int. Cl. G06Q 30/02

(52) U.S. Cl. CPC G06Q 30/0281

(57) ABSTRACT

An information management apparatus, comprising a transmitting unit that transmits service information on a given service to a plurality of users, and a calculation unit that for each of the users of the service, calculates a degree of familiarity with a given dealer as to the service, wherein the service information includes sub-information for each of the users to use to proceed with a procedure for receiving the service, the calculation unit calculates the degree of familiarity, based on a communication history of the user, and the transmitting unit transmits the sub-information to a user whose degree of familiarity is lower than a reference value, and inhibits transmission of the sub-information to a user whose degree of familiarity is higher than the reference value.

### CROSS-REFERENCE TO RELATED APPLICATION(S)

This application claims priority to and the benefit of Japanese Patent Application No. 2022-035567 filed on Mar. 8, 2022, the entire disclosure of which is incorporated herein by reference.

### BACKGROUND OF THE INVENTION

### Field of the Invention

The present invention relates to an information management apparatus.

### Description of the Related Art

Some services dealing with products require that before a user’s purchasing a product, comparisons and examinations related to purchase of the product be carried out. For example, in a vehicle trade-in service, the current vehicle is assessed before purchase of a new vehicle (see Japanese Patent Laid-Open No. 2003-173404).

A user often feels that communication in such a service is a hassle. Today, as forms of services are diversified day by day, further improvement in usability is in demand.

### SUMMARY OF THE INVENTION

An exemplary object of the present invention is to improve usability in providing a variety of services.

One of the aspects of the present invention provides an information management apparatus, comprising a transmitting unit that transmits service information on a given service to a plurality of users, and a calculation unit that for each of the users of the service, calculates a degree of familiarity with a given dealer as to the service, wherein the service information includes sub-information for each of the users to use to proceed with a procedure for receiving the service, the calculation unit calculates the degree of familiarity, based on a communication history of the user, and the transmitting unit transmits the sub-information to a user whose degree of familiarity is lower than a reference value, and inhibits transmission of the sub-information to a user whose degree of familiarity is higher than the reference value.

Further features of the present invention will become apparent from the following description of exemplary embodiments with reference to the attached drawings.

### BRIEF DESCRIPTION OF THE DRAWINGS

FIG. 1 is a diagram for explaining a configuration example of a service system according to an embodiment;

FIG. 2 is a flowchart showing an example of a form of providing a service;

FIG. 3 is a flowchart showing another example of a form of providing a service;

FIG. 4 is a flowchart showing still another example of a form of providing a service; and

FIG. 5 is a flowchart showing still another example of a form of providing a service.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

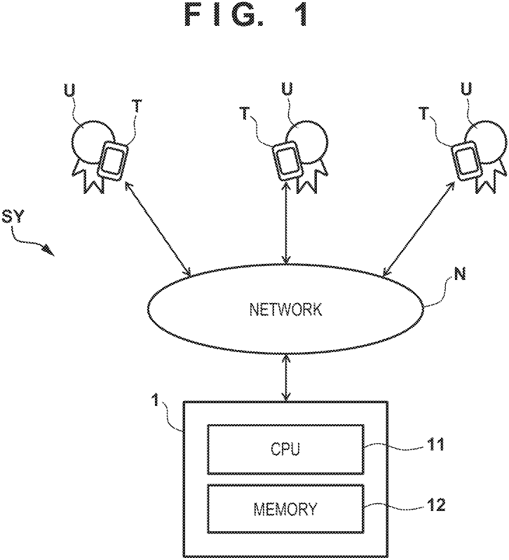

FIG. 1 is a diagram for explaining a configuration example of a service system SY according to a first embodiment. The service system SY includes a plurality of terminals T a plurality of users U own, respectively, and an information management apparatus 1 capable of communicating with the terminals T. Each terminal T is typically a portable terminal, such as a smartphone, but may be a personal computer (PC) or another electric device with a communication function, such as a smart watch or a game machine. The terminal T may be referred to as a communication terminal or the like. The information management apparatus 1 can communicate with each terminal T via a network N, and manages information on the user U who owns the terminal T, which will be described later.

The information management apparatus 1 includes a central processing unit (CPU) 11 and a memory 12. The CPU 11 loads a given program onto the memory 12 to allow implementation of various functions, which will be described later. In another example, the information management apparatus 1 may be composed of an application specific integrated circuit (ASIC), and it’s functions may be implemented as a result of execution of a given program by at least one processor circuit with a memory. In other words, the functions of the information management apparatus 1 can be implemented by software and by hardware as well.

The information management apparatus 1 may be referred to as an information processing apparatus 1, an information providing apparatus 1, or the like.

In such a service system SY, the information management apparatus 1 provides information on a service to the user U via the network N and the terminal T, and receives an order for a service from the user U via the terminal T and the network N. The service includes, for example, a vehicle sales service, a vehicle purchase service, and a service of sending/distributing a notification of maintenance of a vehicle the user already has, and the vehicle sales service includes confirmation of information on a vehicle to sell and test drive reservation. In this embodiment, the above service further includes a trade-in service. In the vehicle trade-in service, the user U is able to sell a vehicle the user U owns and to use money obtained by selling the vehicle for the purchase of a new vehicle (next/another vehicle).

Hereinafter, for simpler description, a vehicle to sell is referred to as a vehicle Vo and a new vehicle is referred to as a vehicle Vn. The vehicle Vn is not limited to specific one vehicle, and may be one or more vehicles selected from a plurality of candidates for vehicles to purchase.

It should be noted that a conception of service is interpreted in a broad sense and that in the present specification, the conception of service includes not only the product and regular service provided to the user U but also part of customer services provided to the user U in the course of offering the product and regular service. Such part of customer services, to make it distinctive, may be referred to as a sub-service.

In this embodiment, a trade-in service will be described exemplarily. In this service, the user U first makes an assessment of the vehicle Vo and then considers purchase of the vehicle Vn, based on assessment results. In many cases, the user U makes the assessment of the vehicle Vo on a website, using the terminal T. This approach allows the user U to make the assessment of the vehicle Vo relatively easy without involving a direct meeting, consultation, or the like with a dealer (car dealer, other intermediaries, etc.).

After the assessment of the vehicle Vo, the user U may contact the dealer and discuss the purchase of the vehicle Vn when necessary. In any case, however, the user U is the one who decides an actual action to take. In other words, it is required that a follow-up service for the user U having finished with the assessment of the vehicle Vo be provided in a proper form for the user U.

To meet this requirement, the service system SY of this embodiment first provides the user U with a service in a preparation stage for considering purchase of the new vehicle Vn (a service for assessing the vehicle Vo), and changes a form of a follow-up service (a service for actually proceeding with procedures for purchasing the vehicle Vn) provided to the user U on a necessary basis.

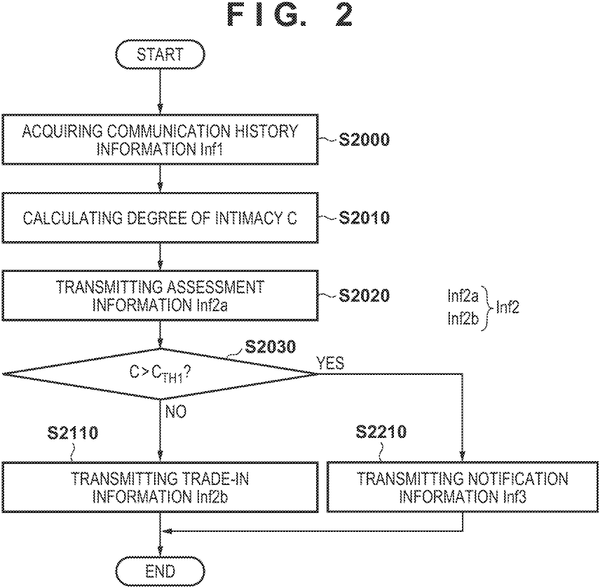

FIG. 2 is a flowchart showing an example of a form of providing a service according to this embodiment. This flowchart is created mainly by the information management apparatus 1, and processes executed according to the flowchart are summarized as a process of calculating a degree of familiarity of the user U with a service, the user U making an assessment of the vehicle Vo, and a process of changing a form of providing a follow-up service according to the degree of familiarity.

At step S2000 (which will hereinafter be simply expressed as “S2000” and other steps to follow will be expressed in the same manner), information indicating a history of communication between each user U and the dealer is acquired as communication history information Inf1.

A concept of communication typically includes forms of communication made through an electric communication line, such as making telephone calls and sending/receiving e-mails, but may also include forms of communication made not through an electric communication line, such as visiting a store or meeting or consulting a person in charge. In the case of communication made not through the electric communication line, the dealer is allowed to record or enter results of the communication in a management terminal. The communication history information Inf1, therefore, is acquired mainly from the terminal T of the user U in the case of communication made through the electric communication line, but is acquired from the management terminal of the dealer in the case of communication made not through the electric communication line.

At S2010, based on the communication history information Inf1 of each user U, a degree of familiarity C of the user U with a service is calculated. In this embodiment, the degree of familiarity C is considered to be the degree of familiarity with the dealer who provides all or part of the service, but may be the degree of familiarity with the service itself. For example, the higher the degree of familiarity C, the smaller the degree of trouble the user U undergoes when proceeding with procedures for the service, or at least the user U tends to feel less troublesome when proceeding with the procedures.

The above calculation of the degree of familiarity C is carried out using an arithmetic expression operated according to a given program, and may be carried out by artificial intelligence (AI) as well. In the latter case, for example, a leaming device, which is a computer including a neural network made up of an input layer, an intermediate layer, and an output layer, can be used. The computer includes a convolutional neural network (CNN), and provides a machine learning environment through such a network configuration. Machine learning is referred to also as deep learning. An auto encoder, for example, may be adopted in place of or in addition to the CNN. In view of this, the above calculation may be expressed as determination, setting, or the like or as evaluation, estimation, or the like.

In this embodiment, the degree of familiarity C is calculated by weighted addition of a plurality of items of the communication history information Inf1. The plurality of items include, for example, an item representing the number of times of the user U contacting the dealer, an item representing the number of times of the dealer contacting the user U, and the like, and these parameters are used for the calculation. More specifically,
the number of times of the user U telephoning the dealer is defined as Ts,
the number of times of the dealer telephoning the user U is defined as T_{R},
the number of times of the user U e-mailing the dealer is defined as Ms, and
the number of times the dealer e-mailing the user U is defined as M_{R}.

In such a case, the degree of familiarity C is calculated by weighted addition using coefficients a1 to a4, which, for example, gives the following equation:

$${\text{C=T}}_{\text{S}} {\text{×a1+T}}_{\text{R}} {\text{×a2+M}}_{\text{S}} {\text{×a3+M}}_{\text{R}} \text{×a4} \text{.}$$

The coefficients a1 to a4 may be referred to as weighted addition coefficients, weighting coefficients, or the like. The coefficients a1 to a4 are set based on the importance of the parameters Ts, T_{R}, Ms, and M_{R}, and may be changed when necessary. For example, when it is assumed that the user U contributes more to the degree of familiarity C than the dealer when the one that makes the phone call or sends the e-mail is the user rather than the dealer,
a1>a2 and/or
a3>a4

may be set. This means that the coefficients a1 and a3 applied to the number of times of the user U contacts the dealer are larger than the coefficients a2 and a4 applied to the number of times of the dealer contacts the user U, respectively.

When it is assumed that telephoning contributes more to the high degree of familiarity C than e-mailing,
a1>a3 and/or
a2>a4

are set. This means that the coefficients a1 and a2 applied to the number of times of telephoning are larger than the coefficients a3 and a4 applied to the number of times of e-mailing, respectively.

Because it is assumed that the dealer will in any case telephone or e-mail the user U incidentally as part of its service,
a2=0 and/or
a4=0

may be set. In other words, the number of times that the dealer telephones or e-mails the user U is not used for the calculation of the degree of familiarity C.

The lengths of telephone calls and the frequency of making phone calls are taken into consideration, and the parameters Ts and/or T_{R} may be corrected or the values of the coefficients a1 and a2 may be set accordingly. Likewise, as to e-mailing, the number of characters, the data volume, and the frequency of e-mailing are taken into consideration, and the parameters Ms and/or M_{R} may be corrected accordingly. In short, the degree of familiarity C may be corrected based on communication details.

At S2020, information Inf2a on an assessment of the vehicle Vo is transmitted to the user U, as sub-information for considering the procedures for the service (hereinafter, this information Inf2a will be referred to as assessment information Inf2a.). The assessment information Inf2a mainly provides information on the sale price of the vehicle Vo, which sale price may also be referred to as an assessment price. The assessment information Inf2a is typically a website for vehicle assessment, but, as another example, may be a reference table with which the user U himself or herself is able to assess each vehicle, based on the type of the vehicle, a use history of the vehicle, and the like. In the case of the website, the assessment of the vehicle Vo is made by given calculation processes, based on input information from the user U. In the case of the reference table, the assessment is made depending on the user U’s own judgements. Based on assessment results obtained through the above process, the user U is able to determine whether or not to purchase the vehicle Vn.

At S2030, whether the degree of familiarity C of the user U is higher than a reference value C_{TH1}, the user considering the purchase of the vehicle Vn, which is a follow-up procedure, based on the assessment information Inf2a, is determined. In this embodiment, the process flow proceeds to S2110 when the degree of familiarity C is lower than the reference value C_{TH1}, and proceeds to S2210 when the degree of familiarity C is higher than the reference value C_{TH1}.

At S2110, information Inf2b on the purchase of the vehicle Vn is transmitted to the user U, as sub-information for considering the purchase of the vehicle Vn, which is the follow-up procedure (hereinafter, this information Inf2b will be referred to as trade-in information Inf2b). The trade-in information Inf2b mainly provides information on the purchase price of the vehicle Vn, and when the assessment information Inf2a is the website for vehicle assessment, may include information corresponding to the sale price of the vehicle Vo. In such a case, information on the vehicle Vn whose purchase price is within a given range from the sale price of the vehicle Vo may be transmitted as the trade-in information Inf2b.

The user U is thus able to proceed with procedures for receiving a trade-in service in response to the trade-in information Inf2b, that is, is able to consider a transaction of selling the vehicle Vo and purchasing the vehicle Vn without intermediary work by the dealer.

At S2210, transmission of the trade-in information Inf2b is inhibited and other information Inf3 for the user U to actually proceed with the procedures for receiving the trade-in service is transmitted to the dealer, instead. The information Inf3 includes information for notifying the dealer of a fact that the user U having a relatively high degree of familiarity C is considering the purchase of a vehicle (hereinafter, the information Inf3 will be referred to as notification information Inf3). Receiving the notification information Inf3, the dealer is able to try making direct contact with the user U by phone or e-mail.

The user U is thus able to proceed with the procedures for receiving the trade-in service in response to the contact made by the dealer, that is, is able to consider a transaction of selling the vehicle Vo and purchasing the vehicle Vn through intermediary work by the dealer.

In short, when the degree of familiarity C calculated on each user U is lower than the reference value C_{TH1} (in the case of S2110), it is assumed that the user U may feel direct contact by the dealer bothersome. To such a user U, therefore, the trade-in information Inf2b is provided and the follow-up service is indirectly provided as well.

When the degree of familiarity C is higher than the reference value C_{TH1} (in the case of S2210), on the other hand, it is assumed that the user U is highly likely to have a favorable impression on the dealer’s providing direct service. The dealer thus makes direct contact with such a user U and directly provides the user with the follow-up service.

According to such forms of services, the user U is able to receive the trade-in service in the form corresponding to the degree of familiarity C of the user U. This improves usability.

### First Example

In a first example, the above degree of familiarity C may be calculated on a user U who has made a vehicle assessment, based on the assessment information Inf2a, the user U being among a plurality of users U. In other words, when the trade-in service is divided into an assessment service for assessment of the vehicle Vo (a sub-service that is a pre-stage to a sale service) and a purchase service for purchase of the vehicle Vn, the degree of familiarity C is calculated on a user U who has received the assessment service.

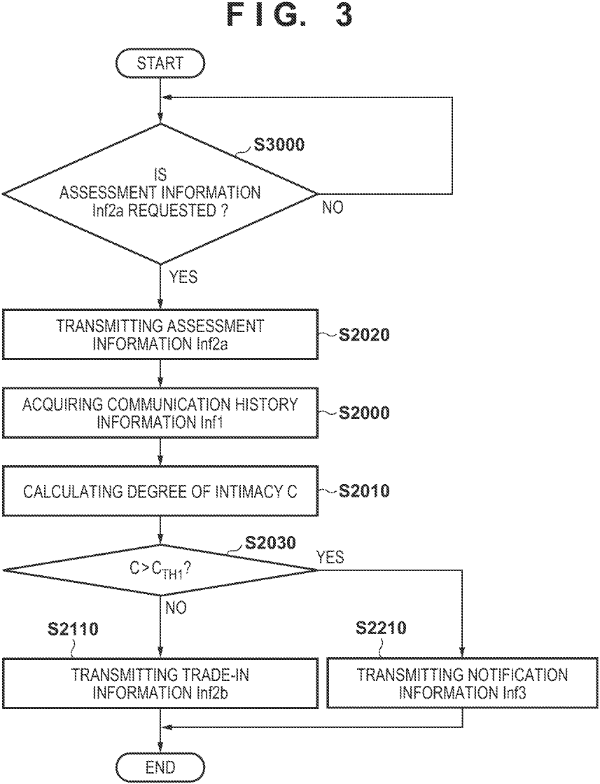

FIG. 3 is a flowchart showing a form of providing a service according to the first example. This flowchart can be created by modifying a part of the above-described flowchart (see FIG. 2). First, at S3000, whether a request for the assessment information Inf2a has been made is determined. When the request for the assessment information Inf2a has been made, the process flow proceeds to S2020, but when no request for the assessment information Inf2a has been made, the process flow returns to S3000.

Subsequently, at S2020, the assessment information Inf2a is transmitted to the user U. At S2000, the communication history information Inf1 is acquired. At S2010, the degree of familiarity C is calculated. At S2030, whether the degree of familiarity C is higher than the reference value C_{TH1} is determined. When the degree of familiarity C is lower than the reference value C_{TH1}, the process flow proceeds to S2110, but when the degree of familiarity C is not lower than the reference value C_{TH1}, the process flow proceeds to S2210. At S2110, the trade-in information Inf2b is transmitted to the user U. At S2210, the notification information Inf3 is transmitted to the dealer.

According to the first example, it is possible to improve the usability and is also possible to prevent unnecessary acquisition of the communication history information Inf1 and unnecessary calculation of the degree of familiarity C.

### Second Example

In a second example, when a plurality of dealers are present, a plurality of degrees of familiarity C are calculated for the plurality of dealers at S2010 (see FIGS. 2 and 3).

In this case, at S2030, when at least one of the plurality of degrees of familiarity C is higher than the reference value C_{TH1}, the process flow proceeds to S2210, but when none of the degrees of familiarity C is higher than the reference value C_{TH1} (all the plurality of degrees of familiarity C are equal to or lower than the reference value C_{TH1}), the process flow proceeds to S2110. At S2210, when two or more degrees of familiarity C higher than the reference value C_{TH1} are present, the notification information Inf3 is transmitted to the dealer with whom the degree of familiarity C is the maximum.

When two or more maximum degrees of familiarity C are present, the parameters Ts, T_{R}, Ms, and M_{R} used for calculation of these degrees of familiarity C are compared, and based on the comparison results, the dealer to whom the notification information Inf3 is to be transmitted may be selected or determined. In other words, among two or more degrees of familiarity C, a degree of familiarity C indicating a larger number of times of the user U contacting the dealer is given priority.

For example, among the two or more degrees of familiarity C, a degree of familiarity C satisfying

$${\text{T}}_{\text{S}} {\text{>T}}_{\text{R}}$$

may be given priority, or a degree of familiarity C satisfying

$${\text{M}}_{\text{S}} {\text{>M}}_{\text{R}}$$

may be given priority in place of or in addition to the former degree of familiarity C.

According to such a form of service, even in a case where the user U has made communication with a plurality of dealers, the user is able to receive the trade-in service with support provided by the optimum dealer.

### Third Example

As described with reference to FIG. 2, the above degree of familiarity C is calculated at S2010, based on the communication history information Inf1. Even when the degree of familiarity C is relatively high, however, there may be a case where an actual impression the user U has on the dealer is different from the results of calculation of the degree of familiarity C. It is preferable that, for this reason, a service be provided to the user U as an evaluation of one or more dealers by the user U is taken into consideration. This evaluation is acquired from the user U as information directly indicating the impression the user U has on the dealer, such as, typically, a questionnaire survey and opinion seeking.

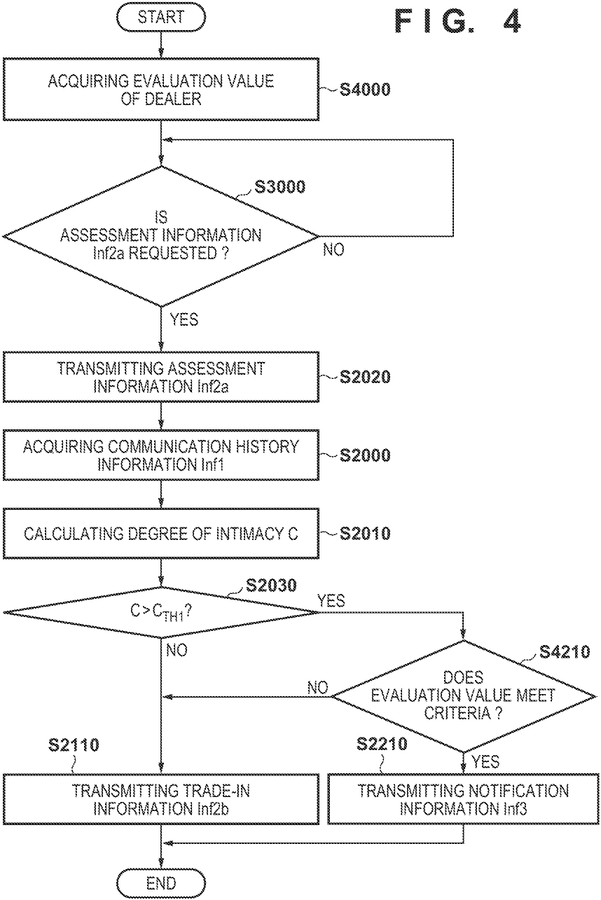

FIG. 4 is a flowchart showing an example of a form of providing a service according to a third example. First, at S4000, an evaluation of the dealer is received from the user U. Examples of the evaluation include a questionnaire survey and opinion seeking. The evaluation is made by, for example, weighted addition of one or more items, is quantified in a plurality of stages (e.g., five stages) and is acquired as an evaluation value.

Subsequently, steps of the flowcharts of FIGS. 2 and 3 are executed. For example, when steps of the flowchart of FIG. 3 are executed, whether a request for the assessment information Inf2a has been made is determined at S3000, the assessment information Inf2a is transmitted to the user U at S2020, the communication history information Inf1 is acquired at S2000, and the degree of familiarity C is calculated at S2010. At S2030, whether the degree of familiarity C is higher than the reference value C_{TH1} is determined. When the degree of familiarity C is lower than the reference value C_{TH1}, the process flow proceeds to S2110, but when the degree of familiarity C is not lower than the reference value C_{TH1}, the process flow proceeds to S4210. At S2110, the trade-in information Inf2b is transmitted to the user U.

At S4210, whether the evaluation value obtained at S4000 meets criteria is determined. When the evaluation value meets the criteria, the process flow proceeds to S2210, but when the evaluation value does not meet the criteria, the process flow proceeds to S2110. At S2210, the notification information Inf3 is transmitted to the dealer. At S2110, the trade-in information Inf2b is transmitted to the user U, instead of transmitting the notification information Inf3 to the dealer (see S2210). In other words, according to the third example, when the evaluation value of the dealer does not meet the criteria, the notification information Inf3 is not transmitted to the dealer, regardless of the degree of familiarity C, and the trade-in information Inf2b is transmitted to the user U, instead.

In another example, at acquisition of the evaluation value at S4000, when a plurality of users U are present, a plurality of evaluation values obtained from the plurality of users U may be corrected. For example, because some users U tend to make biased evaluations, the plurality of evaluation values may be corrected, typically, based on a standard deviation. In other words, evaluation criteria are adjusted among the users U who evaluate the dealer. This approach is particularly advantageous for a case where a plurality of dealers are present. It should be noted that this correction process, which is executed at S4000, may be executed when whether the evaluation value meets the criteria is determined at S4210.

### Second Embodiment

In the above first embodiment, to facilitate understanding, the trade-in service is described as an example of a service to which the degree of familiarity C can be applied. However, services vary in content, and the degree of familiarity C can be utilized in a variety of services.

For example, evaluation of the degree of familiarity C may be made based on communication history information that can be acquired in a different service independent of a service allowing utilization of the degree of familiarity C (this communication history information is defined as “communication history information Inf1′ to distinguish it from the communication history information Inf1). Services allowing utilization of the degree of familiarity C include a browsing service by which the vehicle Vn can be browsed and a related service for other products (e.g., vehicle parts) related to the vehicle Vn. Different services independent of services allowing utilization of the degree of familiarity C may be not related to a series of services allowing utilization of the degree of familiarity C or may be partially, directly, or indirectly related to the services allowing utilization of the degree of familiarity.

Typically, all the above services allowing utilization of the degree of familiarity C are provided on websites. By setting in advance a communication target that can be specified, a keyword that can be extracted, and the like in the communication history information Inf1′ of the user U, therefore, the degree of familiarity C can be evaluated relatively easily, based on the communication history information Inf1′ acquired via the network N.

For example, the browsing service includes a purchase service as a sub-service or can be linked to a purchase service by a provider different from the provider of the browsing service. In other words, the user U browsing the vehicle Vn on a website under a purchase service package can access a different website for vehicle purchase linked to the above website, and is therefore able to receive the purchase service. Upon receiving the purchase service, the user U is able to utilize the degree of familiarity C, and the content of the purchase service may be changed based on the results of evaluation of the degree of familiarity C.

In implementation of such a service, when consent of the user U to acquisition of the communication history information Inf1′ from the user U is necessary, for example, the owner of the information management apparatus 1 is able to get the consent from the user U in advance. This consent may be given according to, for example, a prescribed contract, such as service member registration or user setting.

A browsing service will hereinafter be exemplarily described as an example of a service allowing utilization of the degree of familiarity C. There are, however, a variety of services allowing utilization of the degree of familiarity C, and what is described below can apply to various services.

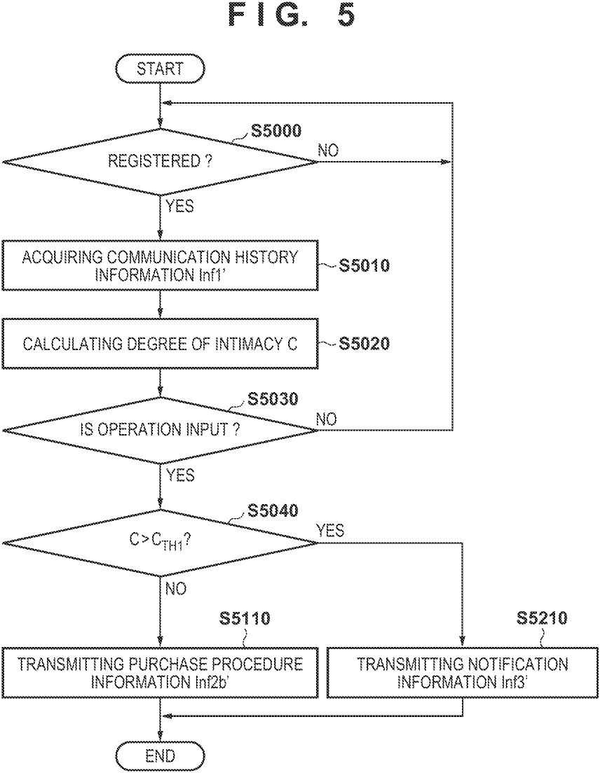

FIG. 5 is a flowchart showing an example of a form of providing a service according to a second embodiment. This flowchart is created mainly by the information management apparatus 1, and steps executed according to the flowchart are summarized as a process of calculating the degree of familiarity C, based on the communication history information Inf1′, and changing a form of proving a service according to the degree of familiarity C.

It is determined at S5000 whether the user U who uses the browsing service has a registered membership. The user has his or her membership registered, based on, for example, a prescribed contract, such as service member registration or user setting, and whether the user U has the registered membership is determined, for example, by referring to a database (not illustrated) included in the information management apparatus 1. When the user U has the registered membership, the process flow proceeds to S5010, but when the user U has no registered membership, the process flow returns to S5000 (or the flowchart comes to an end).

For example, a given application program is installed in the terminal T of the user U determined to be a user having the registered membership. The terminal T is thus able to provide the communication history information Inf1′ to the information management apparatus 1 via the network N.

At S5010, the communication history information Inf1′ is acquired. The communication history information Inf1′ is similar in configuration to the above-described communication history information Infl, and includes information indicating the parameters Ts, T_{R}, Ms, and M_{R}. The content of the parameters may be partially changed, deleted, or increased, based on the content of the service corresponding to the communication history information Inf1′.

At S5020, the degree of familiarity C is calculated, based on the communication history information Inf1′. In the same manner as at S2010, the degree of familiarity C is calculated by weighted addition of items in the communication history information Inf1′.

At S5030, on the browsing service website, whether an operation input for executing the purchase service has been made is determined. Examples of the operation input include tapping or clicking an icon, pressing a button, and inputting characters or a command. Where an operation input for executing the purchase service has been made, the process flow proceeds to S5040, but the operation input has not been made, the process flow returns to S5000.

At S5040, whether the degree of familiarity C is higher than the reference value C_{TH1} is determined. In this embodiment, when the degree of familiarity C is lower than the reference value C_{TH1}, the process flow proceeds to S5110, and when the degree of familiarity C is higher than the reference value C_{TH1}, the process flow proceeds to S5210.

At S5110, purchase procedure information Inf2b′ for proceeding with the purchase service is transmitted to the user U, as sub-information. The purchase procedure information Inf2b′ may be a website for purchasing the vehicle Vn or may be information about a store that sells the vehicle Vn (place, contact, and the like).

The user U is thus able to proceed with procedures for receiving the purchase service in response to the purchase procedure information Inf2b′, that is, the user U is able to consider the purchase of the vehicle Vn without intermediary work by the dealer.

At S5210, the transmission of the purchase procedure information Inf2b′ is inhibited, and notification information Inf3′ is transmitted to the dealer, instead. The notification information Inf3′ includes information for notifying the dealer of a fact that the user U having a relatively high degree of familiarity C is considering purchase of a vehicle. Receiving the notification information Inf3′, the dealer is able to try making direct contact with the user U by phone or e-mail.

The user U is thus able to proceed with the procedures for receiving the purchase service in response to the contact by the dealer, that is, the user U is able to consider the purchase of the vehicle Vn while receiving support service by the dealer.

According to this embodiment, the degree of familiarity C is evaluated, based on the communication history information Inf1′ obtained in a service different from the browsing service, and in the purchase service following the browsing service, the form of providing the purchase service is changed, based on the evaluated degree of familiarity C. According to this embodiment, therefore, the user U is able to receive the purchase service in the form corresponding to the degree of familiarity C. This improves the usability.

It should be noted that some of the examples exemplarily described in the above first embodiment may be combined in the second embodiment.

### Others

In the above embodiments, the trade-in service, browsing service, and purchase service for vehicles have been exemplarily described. These services, however, deal not only the vehicles but also any article belonging to the user U. The embodiments and some modifications exemplarily described therein, therefore, can be applied to various services, and, in response to the diversification of services, may be changed in content without departing from the substance of the embodiment and modifications. This is advantageous for a further improvement in the usability in today’s information society.

In the above description, to facilitate understanding, each element is indicated by a name related to its functional aspect. Each element is, however, not limitedly interpreted as an element having the content described in the embodiments as a main function but may be an element having such content as a supplementary function. Each element is, therefore, not strictly limited by its functional expression, which may be replaced with a similar expression. For example, an expression “apparatus” may be replaced with “unit”, “component”, “piece”, “member”, “structure”, “assembly”, or the like, or may be omitted.

### Summary of Embodiments

Features of the above embodiments are summarized as follows.

A first aspect is an information management apparatus, comprising:
a transmitting unit that transmits service information on a given service to a plurality of users; and
a calculation unit that for each of the users of the service, calculates a degree of familiarity with a given dealer as to the service, wherein
the service information includes sub-information for each of the users to use to proceed with a procedure for receiving the service,
the calculation unit calculates the degree of familiarity, based on a communication history of the user, and
the transmitting unit transmits the sub-information to a user whose degree of familiarity is lower than a reference value, and inhibits transmission of the sub-information to a user whose degree of familiarity is higher than the reference value.

According to this aspect, in an environment where diversified services are offered, the user is able to receive a service in the form corresponding to the degree of familiarity of the user. This is advantageous for an improvement in usability.

In the second aspect, when the degree of familiarity is higher than the reference value, the transmitting unit transmits other information for proceeding with the procedure, to a given dealer.

According to this aspect, the user is able to receive proper support from the dealer, which allows proper implementation of the first aspect.

In the third aspect, the information management apparatus further comprising a receiving unit that receives an evaluation of the dealer from the user, wherein

when the received evaluation does not meet criteria, the transmitting unit does not transmit the other information to the dealer, regardless of the degree of familiarity.

According to this aspect, the first aspect will be correctly achieved.

In the fourth aspect, the information management apparatus further comprising a receiving unit that receives an evaluation of the dealer from the user, wherein

when the received evaluation does not meet criteria, the transmitting unit transmits the sub-information to the user, regardless of the degree of familiarity.

According to this aspect, the first aspect will be correctly achieved.

In the fifth aspect, the information management apparatus further comprising a correction unit that corrects the received evaluation, wherein
the user is one of a plurality of users, and
the receiving unit receives evaluations of the dealer from the plurality of users, and the correction unit corrects the plurality of received evaluations, based on a standard deviation.

According to this aspect, an evaluation that could be biased by the user is corrected.

In the sixth aspect, the calculation unit calculates the degree of familiarity, based on a communication history between the dealer and the user.

According to this aspect, the first aspect will be correctly achieved.

In the seventh aspect, the calculation unit calculates the degree of familiarity by weighted addition of a plurality of items in the communication history.

According to this aspect, the first aspect will be correctly achieved.

In the eighth aspect, in the weighted addition, a coefficient applied to a number of times of the user’s contacting the dealer is larger than a coefficient applied to a number of times of the dealer’s contacting the user.

According to this aspect, the first aspect will be correctly achieved.

In the ninth aspect, the communication includes telephoning and e-mailing.

According to this aspect, the first aspect will be correctly achieved.

In the tenth aspect, in the weighted addition, a coefficient applied to the number of times of telephoning is larger than a coefficient applied to the number of times of e-mailing.

According to this aspect, the first aspect will be correctly achieved.

In the eleventh aspect, the dealer is one of a plurality of dealers, and the calculation unit calculates the degree of familiarity for each of the plurality of dealers, and

the transmitting unit transmits the other information to a dealer with which the degree of familiarity is maximum among the calculated degrees of familiarity.

According to this aspect, even when a plurality of dealers are present, the first aspect is properly implemented.

In the twelfth aspect, when two or more maximum degrees of familiarity are present among the calculated degrees of familiarity, the transmitting unit transmits the other information to a dealer with which a degree of familiarity indicating a larger number of times of the user’s contacting the dealer from among the maximum degrees of familiarity.

According to this aspect, even when a plurality of dealers are present, the first aspect is properly implemented.

The invention is not limited to the foregoing embodiments, and various variations/changes are possible within the spirit of the invention.

What is claimed is:

1. An information management apparatus comprising:
a transmitting unit that transmits service information on a given service to a plurality of users; and
a calculation unit that for each of the users of the service, calculates a degree of familiarity with a given dealer as to the service, wherein
the service information includes sub-information for each of the users to use to proceed with a procedure for receiving the service,
the calculation unit calculates the degree of familiarity, based on a communication history of the user, and
the transmitting unit transmits the sub-information to a user whose degree of familiarity is lower than a reference value, and inhibits transmission of the sub-information to a user whose degree of familiarity is higher than the reference value.

2. The information management apparatus according to claim 1, wherein
when the degree of familiarity is higher than the reference value, the transmitting unit transmits other information for proceeding with the procedure, to a given dealer.

3. The information management apparatus according to claim 2, further comprising
a receiving unit that receives an evaluation of the dealer from the user, wherein
when the received evaluation does not meet criteria, the transmitting unit does not transmit the other information to the dealer, regardless of the degree of familiarity.

4. The information management apparatus according to claim 2, further comprising
a receiving unit that receives an evaluation of the dealer from the user, wherein
when the received evaluation does not meet criteria, the transmitting unit transmits the sub-information to the user, regardless of the degree of familiarity.

5. The information management apparatus according to claim 3, further comprising
a correction unit that corrects the received evaluation, wherein
the user is one of a plurality of users, and
the receiving unit receives evaluations of the dealer from the plurality of users, and the correction unit corrects the plurality of received evaluations, based on a standard deviation.

6. The information management apparatus according to claim 2, wherein
the calculation unit calculates the degree of familiarity, based on a communication history between the dealer and the user.

7. The information management apparatus according to claim 6, wherein
the calculation unit calculates the degree of familiarity by weighted addition of a plurality of items in the communication history.

8. The information management apparatus according to claim 7, wherein
in the weighted addition, a coefficient applied to a number of times of the user’s contacting the dealer is larger than a coefficient applied to a number of times of the dealer’s contacting the user.

9. The information management apparatus according to claim 7, wherein
the communication includes telephoning and e-mailing.

10. The information management apparatus according to claim 9, wherein
in the weighted addition, a coefficient applied to the number of times of telephoning is larger than a coefficient applied to the number of times of e-mailing.

11. The information management apparatus according to claim 6, wherein
the dealer is one of a plurality of dealers, and the calculation unit calculates the degree of familiarity for each of the plurality of dealers, and
the transmitting unit transmits the other information to a dealer with which the degree of familiarity is maximum among the calculated degrees of familiarity.

12. The information management apparatus according to claim 11, wherein
when two or more maximum degrees of familiarity are present among the calculated degrees of familiarity, the transmitting unit transmits the other information to a dealer with which a degree of familiarity indicating a larger number of times of the user’s contacting the dealer from among the maximum degrees of familiarity.
